(19) United States
(12) Patent Application Publication
(10) Pub. No.: US 2008/0308680 A1
(43) Pub. Date: Dec. 18, 2008

(54) Device to improve the positioning of a retardation system of a parachute canopy by magnetism

(76) Inventor: Eric Fradet, Tallard (FR)

Correspondence Address: COLLARD & ROE, P.C., 1077 NORTHERN BOULEVARD, ROSLYN, NY, 11576, US

(21) Appl. No.: 12/214,323

(22) Filed: Jun. 18, 2008

(30) Foreign Application Priority Data
Jun. 18, 2007 (FR) FR 0704341

(51) Int. Cl. B64D 17/52

(52) U.S. Cl. 244/149

(57) ABSTRACT

The device enables the gradual opening of the parachute canopy, round or square, during the spreading phase of the canopy (12), by an arrangement on the lower surface (30) of the canopy (12), combined with an arrangement on the slider (26) comprising at least a magnetic element (Z) provided on the canopy, which is attracted by at least another element (M) which is positioned on the slider (26).

The device ensuring the holding of the slider (26) on bottom of the canopy during the spreading phase, thus ensuring that the slider (26) will not be displaced before the woven fabric (50) takes the shape of a dome (42) during this spreading phase prior to the inflating phase of the canopy (12), as it was the case in the prior art.

### CROSS-REFERENCE TO RELATED APPLICATIONS

Applicant claims priority under 35 U.S.C. 119 of French patent application No. 0704341 filed on Jun. 18, 2007.

### BACKGROUND OF THE INVENTION

The present invention relates to a device for a parachute, enabling the gradual opening of a round or square parachute canopy.

This can be obtained by an arrangement on the lower surface of the canopy, combined with an arrangement on the air brakes for the canopy opening, currently called a parachute “slider”.

The slider, invented by J. Floyd Smith in 1948 and adapted on hemispherical parachutes, is currently found on many modern parachute. For example, nowadays, sliders of 44 m² on canopies carrying very heavy loads can be found.

The canopy opening proceeds in three distinct phases in order to be progressive and gradual: deployment, spreading and inflation.

The slider's principle is to be automatically deployed between the spreading and inflation of the parachute canopy, so as to exert a retardation phase to enable a canopy opening at a sufficiently low speed, the slider aims therefore at deflecting the air flow during the spreading phase of the canopy and thus at slowing down the opening from the suspension lines stretch to the end of the canopy spreading, the phase just before its inflation.

The slider consists of a woven fabric, a face of which forms a lower surface and the other an upper surface, the piece of fabric can be flat or bell-shaped, the slider is inserted between the canopy and the load (or the parachutist), and comprises on its contour a plurality of grommets or metal rings through which pass groups of parachute suspension lines and steering lines.

More specifically in a parachute, the load or parachutist is hung on the canopy by a plurality of suspension lines, these suspension lines have their upper ends attached to a lower part of the canopy, the attachment points of these suspension lines being distributed on this lower part.

The lower ends of the suspension lines are gathered into several groups, each group of suspension lines being connected to the load (or parachutist) by a riser.

The slider generally has a square or rectangular contour and the rings or grommets are positioned at the contour corners, but other shapes can be used such as, for example, polygonal shapes. The size and the shape of the slider define the setting of the canopy opening, a slider thus cannot be changed without impacting the opening phase.

This is the retardation device most widely used. The optimisation of the slider surface strongly determines the opening phase control.

The slider is subject to strong constraints, in particular when it equips load canopy parachutes planned to be dropped at a very high altitude.

During packing, the slider is moved up to the top of the line set in order to entangle it, at the lower surface of the parachute canopy, such that it rests against slider stops especially built for this purpose.

These slider stops are installed on all canopies, since in absence of slider stops, the line attachment tabs can then pass through the slider grommets and this one latter can become jammed or damage the stabilizers.

These slider stops can take the shape of a metal ring or of discs inserted and covered by a square piece of fabric positioned on the bottom part of the stabilizers in order to prevent the slider being forced back on the stabilizer.

To obtain a gradual opening sequence, the slider has to be at top of the line set at the beginning of the opening sequence.

While the canopy spreads out, the suspension lines will apply a traction action against the slider. In the horizontal plane, the mechanical resistance of the slider will oppose the traction of the different suspension lines groups, and thus to the full opening of the canopy.

In the vertical plane, the aerodynamic drag generated by the relative wind on the slider will oppose to this pulling, prevent or slow down the slider descent.

So that when it works appropriately, the slider takes the shape of a dome, pushed down by the relative wind and resists in its descent by friction on the suspension lines: it will thus slow down the opening spreading of the line set.

As the parachute canopy inflates, the speed decreases, the aerodynamic drag decreases, the slider comes down, the suspension lines tend to get away at each other, until the total canopy and suspension lines opening, whereby the slider is pushed toward the load or the parachutist.

Thus the slider will completely be down once the canopy is completely open, in a low position, the slider is stabilized and can be collapsed.

Under particular use, in particular, for example, when using load parachutes or when using sports parachutes equipped with sleeves, it was noted that the slider is not held against slider stops during the opening.

Further, the opening of some canopies is conditioned by a particular positioning of the slider during the packing in order to partially mask the leading edge of the canopy.

When the slider is incorrectly positioned during packing, it turns up in the spreading phase sequence of the canopy, in an oblique way below the canopy lower surface, such that its action can thus be significantly decreased, or inexistent.

As a consequence, the parachute can open violently, which can be dangerous for the person and/or harmful to the carried load.

### BRIEF SUMMARY OF THE INVENTION

An object of the invention is a parachute comprising a canopy and an opening retardation system, said opening system consisting of a slider and slider holding means, said means comprising at least a pair of magnetic elements, one magnetic element of each pair being a permanent magnet and the other magnetic element of each pair being a permanent magnet or a material that is attracted to a permanent magnet, and, for each pair, one magnetic element being positioned on the lower surface of the canopy and the other magnetic element being at a location on the slider such that it overlays the one magnetic element and adheres to it by magnetism, maintaining the position of the slider during packing and conditioning.

Preferably, said slider is provided with grommets for the passage of stabilizers of the canopy and said slider holding means are arranged so that, during the spreading phase of the canopy, the contact of said grommets of said slider against slider stops on said stabilizers of the canopy is assured.

Preferably, said slider holding means are arranged to ensure by magnetism the holding of the slider in order for a woven fabric constituting said slider to take the shape of a dome before the slider holding means release.

Preferably, said slider holding means are arranged so that their release occurs at the inflating phase of cells of canopy.

Preferably, said slider holding means are selected to have sufficient attraction to hold said slider in place until it is pulled off by the opening of the canopy.

Preferably, for each pair of magnetic elements, the attraction force of the magnetic element on the canopy is produced with an alternating positive and negative twin poled assembly or with a single pole located at the lower surface directed toward the slider.

Preferably, for each pair of magnetic elements, the attraction of the magnetic element on the slider is produced with an alternating positive and negative twin poled assembly directed toward the lower surface, arranged in a direction opposite to the one on the canopy, or with a single opposite pole directed toward the lower surface of the canopy.

Preferably, for each pair, the magnetic element provided on the lower surface of the canopy is located alone or in combination with others, provided either on or near the slider stops, or on the trailing edge, or on the centre cell, or any other location of the lower surface of the canopy.

### BRIEF DESCRIPTION OF THE SEVERAL VIEWS OF THE DRAWING

Others advantages and characteristics of the invention will become apparent from the following detailed description of exemplary and non-limiting embodiments of the invention, as well as of the accompanying drawings and in which:

FIG. 1 is a perspective view of a parachute at the end of the spreading phase, comprising a preferred embodiment of the device according to the invention.

FIG. 2 is a perspective view of a parachute at the end of the spreading phase, comprising a variation of the device according to the invention.

FIG. 3 is a perspective view of a parachute, in open position and fully inflated, provided with the device according to a preferred embodiment of the invention.

FIG. 4 is a detailed view of the device according to a preferred embodiment of the invention, positioned on the slider.

FIG. 5 is a detailed bottom view of the device according to a preferred embodiment of the invention, positioned on the canopy.

FIG. 6 is a view of the positioning device according to the preferred embodiment, during packing.

FIG. 7 is a top view of the slider provided with a variation of the device according to the invention.

FIG. 8 is a side and enlarged view of the slider provided with the variation of the device according to the invention, during the spreading phase.

FIG. 9 is a perspective view of a parachute, in an open position and fully inflated, provided with a variation of the device according to the invention.

FIG. 10 is a view of the arrangement of a variation of the device according to the invention during packing.

FIG. 11 is a detailed view of FIG. 10.

FIG. 12 is a top view of the slider according to a variation of the device according to the invention.

FIG. 13 is a view of the positioning device on a three cellular-canopy during packing, according to a variation of the device according to the invention.

FIG. 14 is a top view of the device arranged on a mesh slider.

FIG. 15 is a view of the positioning at packing time according to the variation of the invention shown on FIG. 14.

### DETAILED DESCRIPTION OF THE INVENTION

An objective of the device according to the invention will thus be to provide a system perfectly ensuring the automatic positioning of the slider during packing, at low cost, which could be adapted to parachutes to be dropped at the altitudes usually practiced in sport parachuting, as well as to parachutes to drop persons or very heavy loads for military purposes at altitudes higher than 6,000 meters.

The device according to the invention enables the drastic reduction of the risks associated with this incorrect arrangement of the slider, which leads to violent opening shocks, one of the purposes of the invention being to provide a system that reliably and efficiently holds the slider against the slider stops, until the inflation of the canopy surface under the effect of the air flow entering the parachutes cells, forces down the slider by sliding through the grommets guiding its descent.

The main objective of the invention is to optimise the functionality of the slider which consists in physically reducing the opening shock caused by the canopy deployment.

In this respect, an object of the invention is to position preferentially a first magnetic element Z on the lower surface and at the centre of the leading edge 34 of the canopy 12, combined with another magnetic element M positioned at the centre of the slider 26 on the side towards the leading edge 34 of the canopy.

Such a combination aims at keeping a physical restriction of the slider 26 at the lower surface 30 of the canopy 12, whereby avoiding the premature descent of the slider.

The slider descent only occurs during the inflation of the cells 32 that pressurize the canopy 12 and forces the slider 26 downwards.

This arrangement according to the invention ensures the best holding of the slider 26 against its slider stops B, in operational alignment with the stabilizer panels of the canopy when the slider 26 is in its upper position, as positioned during packing.

The holding device includes at least a first magnetic element Z provided on the canopy 12, adapted to create a first magnetic field and at least a second magnetic element M provided on the slider 26, such that they are secured to each other, while being releasable.

In another embodiment of the device according to the invention, the second element M can be a non-magnet element but comprises a material which is attracted to the first element.

The arrangement of the second magnetic element M on the slider can be set back from the slider 26 edge, between the reinforcement tape of the circumferential frame 40 and the centre of the woven fabric 50 in order to reduce the surface area of the lower surface 30 exposed to the relative wind during the opening, without changing at all the spirit of the invention.

Similarly, in another embodiment of the invention, the magnetic element Z positioned on the central cell can be set back recessed from the leading edge 34, and in combination with a magnetic element M in the centre of the slider 26, without changing at all the spirit of the invention.

In a preferred embodiment of the invention, the magnetic elements M and Z take the shape of complementary Magnet Blocks, in order to avoid that, during the repeated attraction between both poles of the magnets during packing, the shocks produce breakages with magnet chips.

The magnetic element Z can have the shape of a disk or ring, securable by bonding or stitching to the lower surface 30 of the canopy.

In an improvement of the invention, another magnetic element Z can be added on the middle of the trailing edge in combination with another magnetic element M disposed on the circumferential frame 40 of the slider 26 on the trailing edge 36 side.

The arrangement of the device according to the invention in its preferred embodiment enables the second magnetic element M to adhere by itself to the first magnetic element Z during packing until the canopy 12 opening forces, applying as known per se on the slider 26, lead as usual to the loss of adhesion of the magnetic elements M and Z with each other, and to the descent of the slider 26 along the suspension lines 16 which converge towards their respective risers 20.

A variation of the device according to the invention aims at providing at least a first magnetic element Z on one of the slider stops B of the slider 26, combined with providing at least another magnetic element M proximate to the grommet 38 swaged on the slider 26.

In this variation according to the invention, the first magnetic element Z is preferably a disk or a ring which is securable by bonding or stitching in a square piece of fabric at the periphery of the canopy 12, in the form of a slider stop B of the slider 26, in the same way as it is made currently with discs or rings.

In this variation according to the invention, said at least second magnetic element M added at the grommets 38 of the slider 26 is at a location, at the periphery of the slider 26, corresponding to come into contact with said first magnetic element Z during the packing of the canopy.

In this variation according to the invention, several of said first magnetic elements of same type Z can be added as a slider stop B of the slider, at the periphery of the canopy 12 in combination with said second elements M at the grommets 38 level of the slider 26.

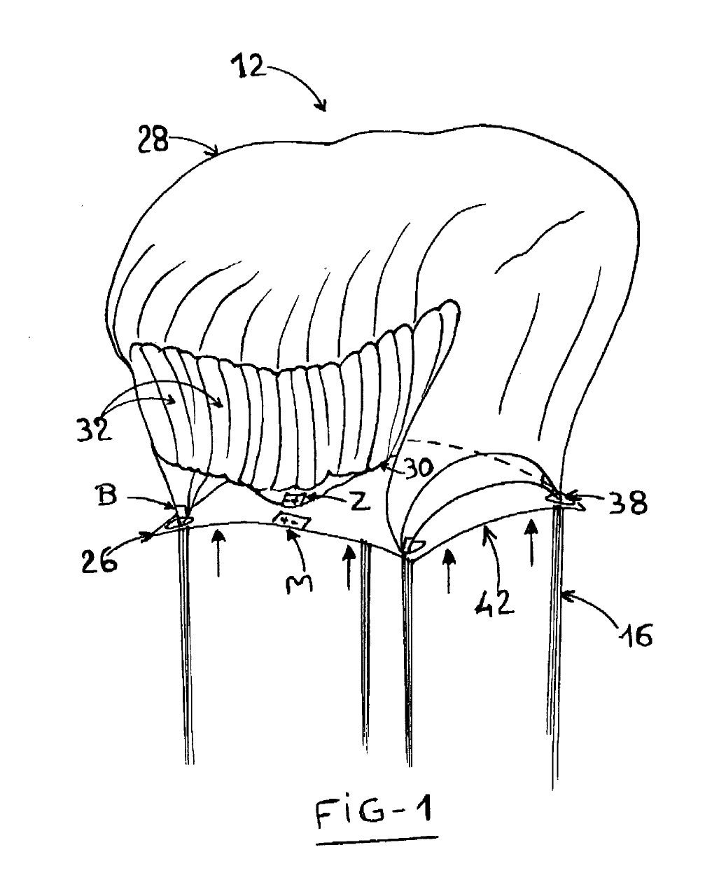

As shown in FIG. 1, during the end of the spreading phase, the canopy 12 opening forces oppose to the resistance forces upwards, materialized by the arrows. As known per se, the canopy 12 has an upper surface 28 and a lower surface 30, separated by cells 32.

The device according to the invention includes resistance locations formed by the magnetic elements Z disposed on the canopy 12 which adhere to the magnetic elements M disposed on the slider 26, such that when the canopy 12 is in the spreading phase, the slider 26 is held in its upper position. As can be seen in FIG. 1, the canopy 12 thus will stay stabilized during a retardation phase, enabling a canopy spreading at a slown down fall rate.

The contact between the magnetic elements M and Z guarantees the holding on top of the slider 26 during the spreading phase of the canopy 12, which ensures that the woven fabric 50 takes the dome shape 42 and does not position in a oblique way under the canopy, a known damage in the prior art devices.

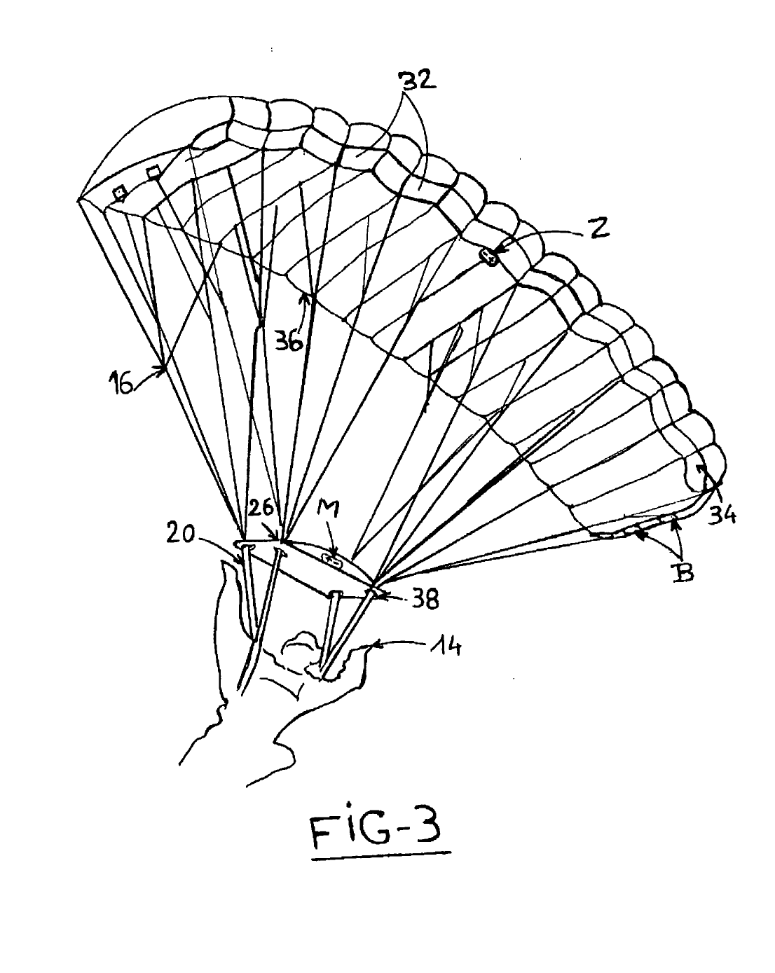

The dome 42 delays due to its shape, the slider's 26 descent from its upper position located immediately below the lower surface 30 of the canopy 12, to its lower position, illustrated in FIG. 3.

The slider's 26 descent thus occurs in a second time during the inflating phase.

With this arrangement, the spreading and inflating phases are chronological and well dissociated, the inflating phase occurring at the precise time when the air flow inflating the parachute cells 32 will force the slider 26 downwards.

The device according to the invention thus ensures a marked passage from the spreading phase to the inflating phase, with the feature of being similar at each opening, which ensures a consistency in the retardation time preceding the full inflation of the canopy, consequently an a shock management at each opening.

The effort distribution is thus better balanced, and avoids situations known in the prior art when the slider 26 is not held on top of the line set 16, under the lower surface 30 and positions itself in a oblique way under the canopy 12, such that its delaying action can then be significantly decreased, or even inexistent.

After this holding phase of the slider 26 in the spreading phase, when the inflation of the parachute canopy 12 occurs, the suspension lines 16 which tend to spread apart from each other finish to force the slider 26 toward the parachutist 14 or the load in an improved way with respect the actual art.

Referring now in detail to the drawings, FIG. 1 illustrates a square parachute, generally referenced by the canopy 12 in a position at the end of the spreading phase and at the beginning of the inflation phase, characterized by air entering the cells 32 and disconnects the magnetic elements M and Z positioned adhering to each other.

The parachute comprises a cells 32 assembly, shown partially inflated, to which is hung a load or a parachutist 14 by means of a line set or suspension lines 16, connected at their lower ends to webbings risers 20 extending from the passenger 14 harness or the load.

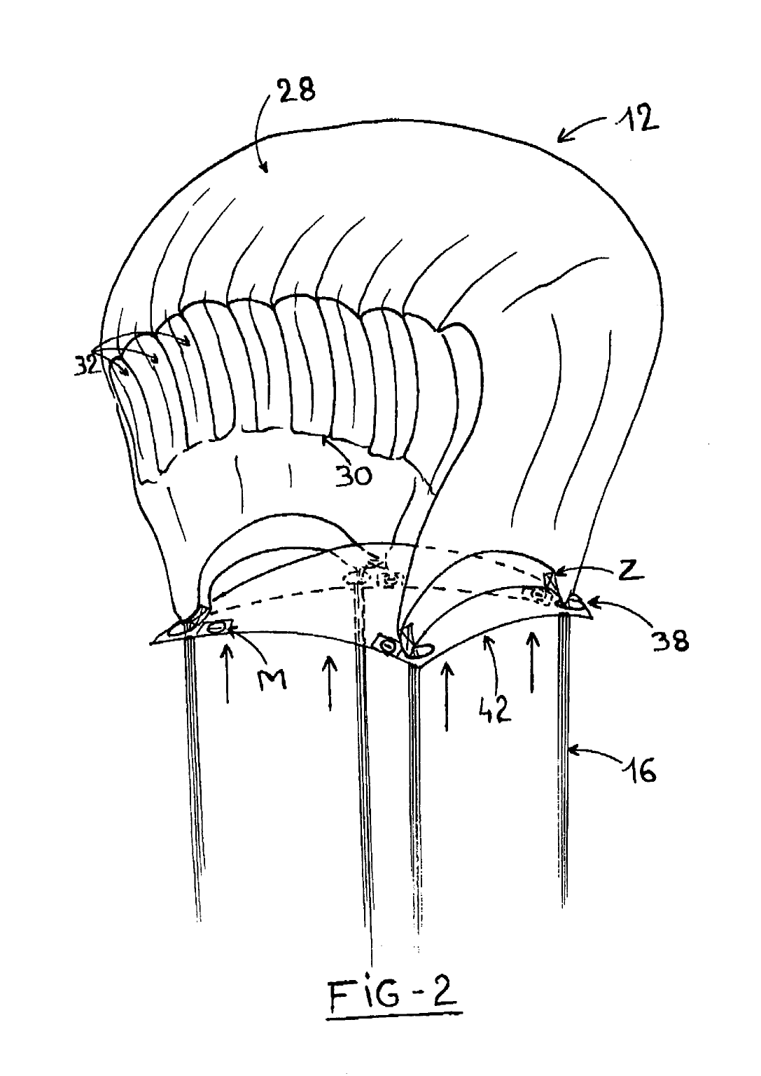

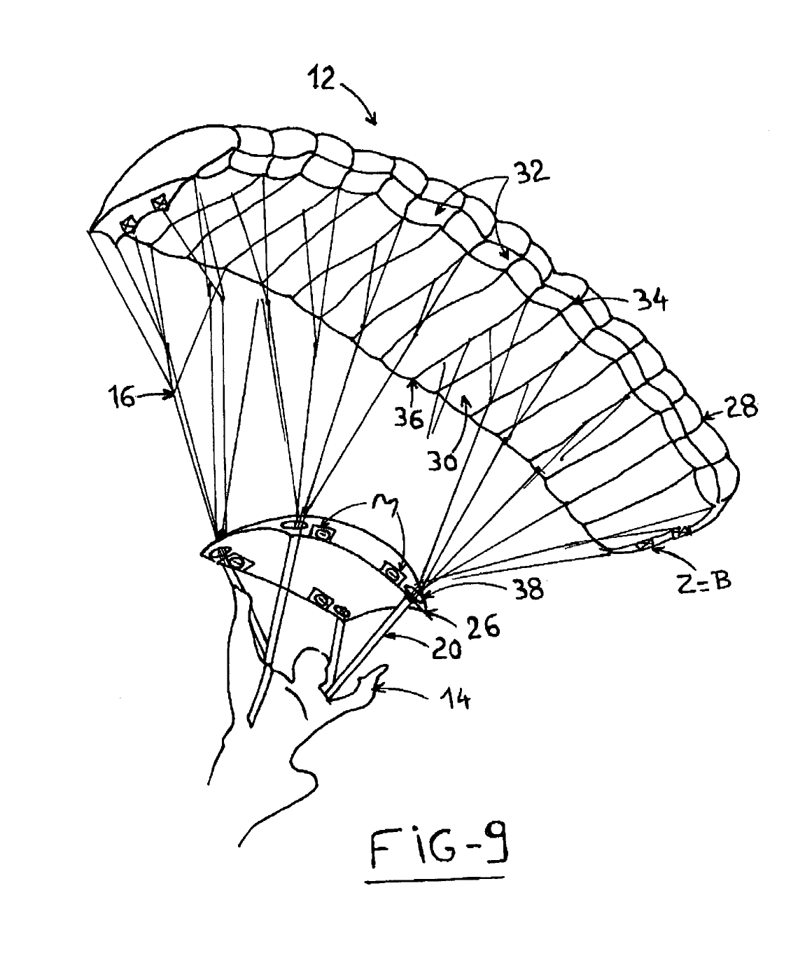

In the shown embodiment, groups of risers 20 bring together groups of suspension lines 16 as known in the art, this arrangement mitigates the descent of a retardation device called slider 26, from a high retardation position such as shown in FIGS. 1 and 2, to a low position, such as shown in FIGS. 3 and 9.

Except for the holding means of the slider 26, the parachute and the associated parts are arranged in a generally known manner per se.

FIG. 3 represents the inflated canopy characterized by the air entered, from the leading edge 34 to the trailing edge 36, which drove the extension of the canopy 12, which becomes fully tensed in the direction of the suspension lines 16 as well as in that of the span, to take its definitive flight shape.

However, according to the present invention, the inflation of the fabric 50 of the slider 26 has not been delayed, limited or modulated thanks to the device according to the invention which has ensured the holding of the slider 26 in its highest position, as shown in FIGS. 1 and 2.

In FIG. 2 we have shown a variation of the device according to the invention.

As shown in FIG. 2, the canopy 12 can thus remain stabilized during a retardation phase, enabling a canopy 12 spreading action at a slown down fall rate.

At the end of the spreading phase, the opening forces due to the canopy 12 inflation oppose in the same way as shown in FIG. 1, to resistance forces directed upward which constitute constituted by the aerodynamic drag materialized shown by arrows.

Thanks to the device according to the invention, these resistance forces have acted on resistance locations formed by the magnetic element(s) Z disposed as slider stop(s) B of the slider on the canopy 12 and the magnetic element(s) M disposed proximate to the grommets 38 of the slider 26.

This adhesion ensures that, when the canopy 12 is in the spreading phase, the slider 26 is held in its upper position, which ensures that the woven fabric 50 of the slider 26 will take the dome shape 42 and not a position in an oblique way under the canopy, damage known in the prior art devices.

The slider 26 descent thus occurs in a second time under the air flow effect which inflates the cells 32 and controls the slider 26 descent.

As shown in FIG. 3, the opening forces of the canopy 12 that have acted on the slider 26 at inflation of the cells 32 entered in opposition to the resistance forces directed upward, characterized by arrows shown in FIG. 1, and have resulted, as known in the improved art, to the descent of the slider 26 along the suspension lines 16, which are convergent toward the four riser 20 groups and toward the parachutist 14 or the load.

The above-mentioned suspension lines 16 extend respectively by sliding through the grommets 38 to guide the slider 26 descent and to physically reduce the canopy 12 opening or deployment under the action of the air inflation forces.

When the parachute is deployed, as shown in FIG. 3, the canopy 12 is normally inflated by the flow of air entering the cells 32 by the leading edge 34 as it is already well known in the improved art, such an inflation drives the extension of the canopy 12 which become fully tense, in its span as well as at the line set 16, to result in the slider 26 descent. The device according to the invention has become inoperative at this phase of the opening shown in FIG. 3.

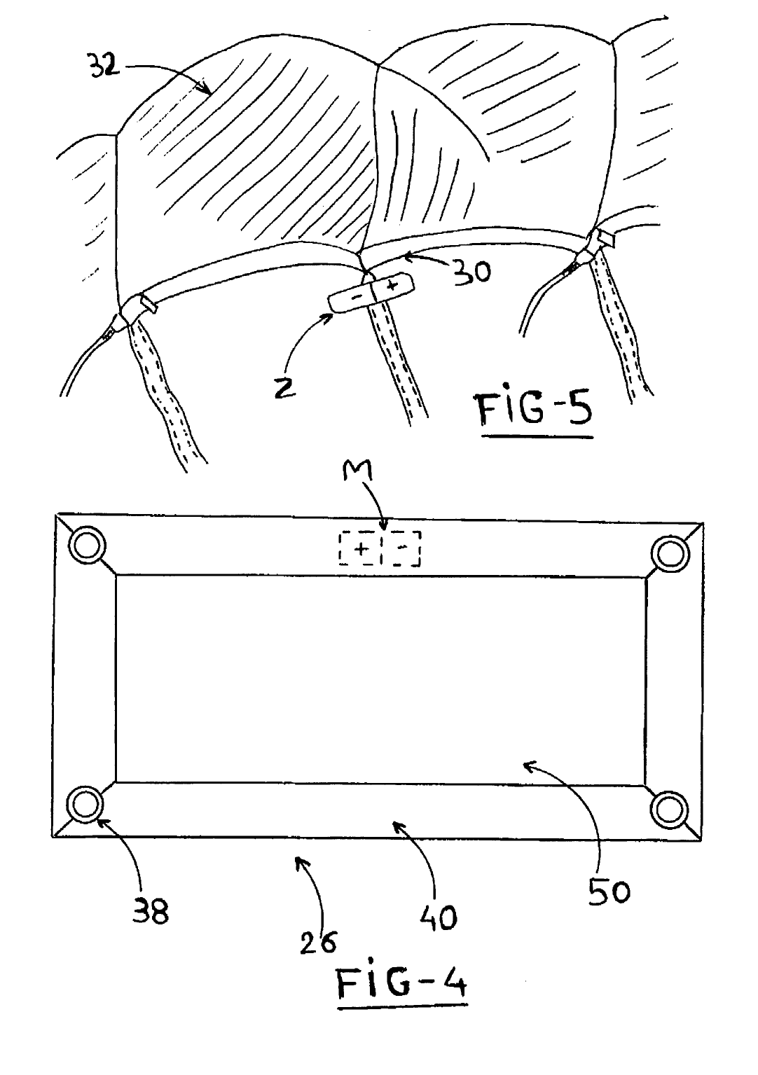

As shown in FIG. 4, the slider 26 consists, as known per se, of a woven fabric 50 whose edges are held by a reinforcement tape attached by stitching to the mounting frame 40.

The side of the slider 26 directed toward the parachutist forms the lower surface, and the other side directed toward the sky forms the upper surface. The woven fabric 50 can be flat or bell-shaped, when it is flat as shown in FIG. 4, the device according to the invention guarantees that it takes at the centre of the circumferential mounting frame 40 the dome shape 42 as shown in FIGS. 1 and 2.

As known per se, the slider 26 comprises on its contour a plurality of grommets 38 through which pass groups of suspension lines 16 of the parachute.

In the embodiment shown in FIG. 4, there are four grommets 38, that are located at the four corners of a rectangular circumferential frame 40 formed by a reinforcement tape, but this frame can be square or polygonal.

The magnetic element M can be positioned indifferently on the upper surface or on the lower surface of the slider 26, the magnetic element M must have its polarity directed towards the opposed polarity of the magnetic element Z attached on the canopy 12.

Preferably, the magnetic element M on the slider is disposed as one or more complementary Magnet Blocks which have alternating positive and negative fields, this magnetic closing mode consists of two complementary “Magnet Blocks” with a tight and alternating polarity, which attract each other when there are brought close.

Each Magnet Block consists of small magnetized ceramics, positioned on one or more rows, bonded to a plastic or rubber support, for example. The use of small magnets enables to obtain the product flexibility, in order to match the shapes of the canopy 12 and of the slider 26.

This arrangement of a magnetic element M on the slider 26, according to a preferred embodiment shown in FIG. 4, is for an adhesion to the magnetic element Z disposed on the lower surface 30 of the canopy 12 and shown in FIG. 5.

The magnetic element Z consists of the same type of Magnet Block(s) which alternate negative and positive fields for an adhesion to each other.

As known per se, the employed magnets interact with each other, two poles of the same polarity repel each other and two poles with different polarities attract.

The respective location of each magnetic element Z and M is selected to be in overlay to one another during packing, by the combined attraction between corresponding magnetic elements.

Thus, in a variation device according to the invention, one or more magnetic elements Z with a positive electric field can be provided at the lower surface 30 of the canopy 12, and one or more magnetic elements M with a negative electric field are provided in the slider 26, this arrangement can be reversed.

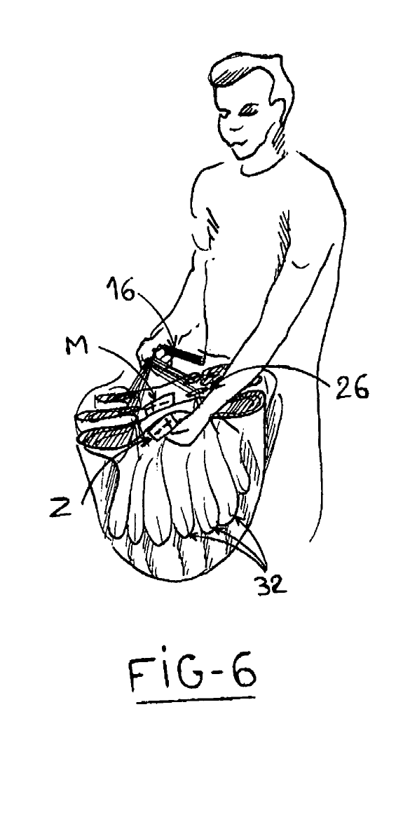

In the example shown in FIG. 6 is shown packing time when the device is activated, when the parachute packer has packed as known per se, the slider 26 in a cross shape between the suspension lines groups A-B-C-D, he then realizes a positioning of the magnetic element Z located on the canopy 12 against the magnetic element M disposed on the slider 26, the magnets automatically adhere when their opposed poles attract, as known per se.

According to the canopy 12 span and the respective positioning of the magnetic element M on the slider 26 and of the magnetic element Z on the canopy, the device according to the invention enables during packing to bring the lower surface 30 of the canopy 12 closer in the direction of the slider 26.

Thus, during packing and conditioning of the canopy into the deployment bag or sleeve, the device is activated and the holding is guaranteed during this packing stage period before use.

When the parachutist operates the opening means, the device ensures the best holding in the position of the slider 26 against the lower surface 30 of the canopy, which causes the slider 26 inflating in a dome shape 42, enabling a gradual passage from the spreading sequence to the inflation phase of the canopy 12.

To increase the holding of the slider 26 to the canopy 12, on oversized canopy models, a higher power of one of the two magnetic elements or both of them enables to reduce the holding effort.

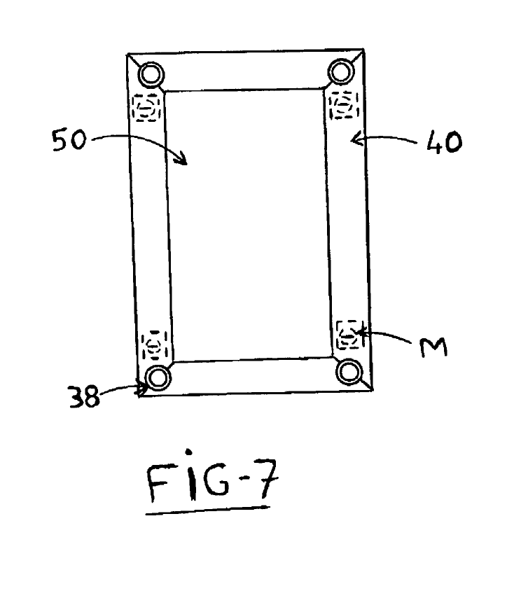

In the embodiment of FIG. 7, the slider 26 comprises several grommets 38 that are spatially connected to each other via a circumferential mounting frame 40 made of fabric.

The magnetic elements M were disposed positioned on the slider 26 into housings on the circumferential reinforcement tape acting as a mounting frame 40, proximate to the grommets 38.

In this exemplary embodiment, the housing are positioned between the grommets 38 in the direction of the wing cord, but they can also be positioned between the grommets 38 in the direction of the wing span.

The magnetic elements M, located on the slider have their poles directed toward the opposite pole of the magnetic elements Z located on the lower surface 30.

The magnetic elements Z are attached in the upper position of the fixations of the outer suspension lines 16, referred to as outer suspension line B and outer suspension line C of the right risers and of the left risers.

This location is materialized by the slider stops B at the lower surface 30 of the canopy 12.

Each magnetic element Z that is attached attracts a second magnetic element M disposed on the slider 26.

Preferably, this magnetic element Z will be of circular shape, such as a disk or ring, as this is the case in the prior art devices: discs or metal rings, which act as a slider stop B for the grommets 38 of the slider.

The position of these magnetic elements is held by a textile screen, as for discs in the prior art devices.

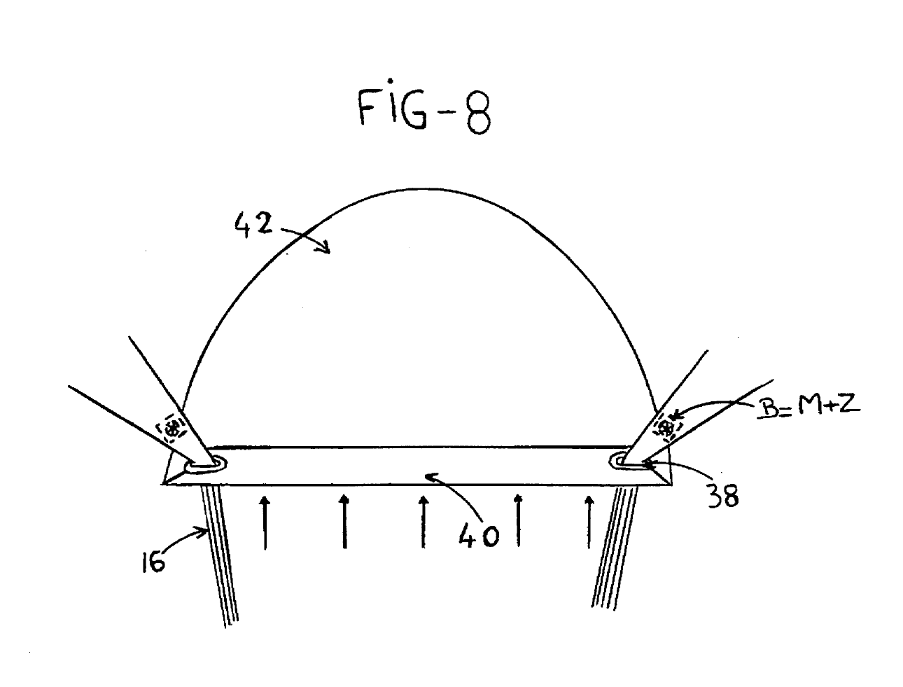

Thus, for example in FIG. 8 is shown the combined arrangement of the magnetic elements Z with the magnetic elements M disposed in the slider 26 at the time of the spreading phase.

We understand that the magnetic elements Z can replace the slider stops B, to replace the slider stops B, or add to the slider stops B positioned at the stabilizer panels of the canopy.

The position of these magnetic elements Z, acting as slider stops B of the slider 26, is perfectly adapted to cooperate during packing, with the conditioning of the slider 26, in order to be positioned in operational alignment with the location of the side panels 35 disposed on the side edge of the canopy 12.

Thus, at opening, the holding occurring by the attraction of each magnetic element Z positioned as a slider stop B cooperates with each magnetic element M disposed with the grommets 38 of the slider 26, so as to ensure the holding of the slider 26 in the upper position during the spreading phase and to cause by the relative wind effect materialized by arrows, the aerodynamic forming of the slider 26 in the shape of a dome 42, which will properly apply resistance forces during inflation of the canopy 12, according to the object of the invention.

These resistance forces also apply on the dome 42 of the slider 26, such as described above in the preferred embodiment of the invention.

The consequence is that the formation into a dome shape 42 coefficient is conditioned by the force of the magnetic elements Z and M which is preferably selected as small as possible, to obtain an optimal physical retardation of the canopy 12, according to the opening kinematics.

By increasing the combined force of the magnetic elements Z positioned in the slider stops B of the slider and of the magnetic elements M attached in the slider 26, the resistance coefficient can be increased to respond to existing retardation needs on some oversized canopies with a heavy load, for example.

The increased resistance has the purpose of delaying the gap of the line set 16 extending through the grommets 38, delay obtained by the physical restriction effect of the slider 26 on top of the lower surface 30.

In FIG. 9 is shown the canopy 12, comprising the variation of the device according to the invention shown in FIG. 8, the canopy is in the open configuration after the inflation phase, in the same situation as that shown in FIG. 3, with the magnetic elements M and Z that became inoperative at that time of the opening, the four magnetic elements M disposed on the slider 26 with their negative polarity can be distinguished entirely separated from the magnetic elements Z with their positive polarity disposed as slider stops B of the slider 26. For example, the polarities can be opposite between the canopy 12 and the slider 26.

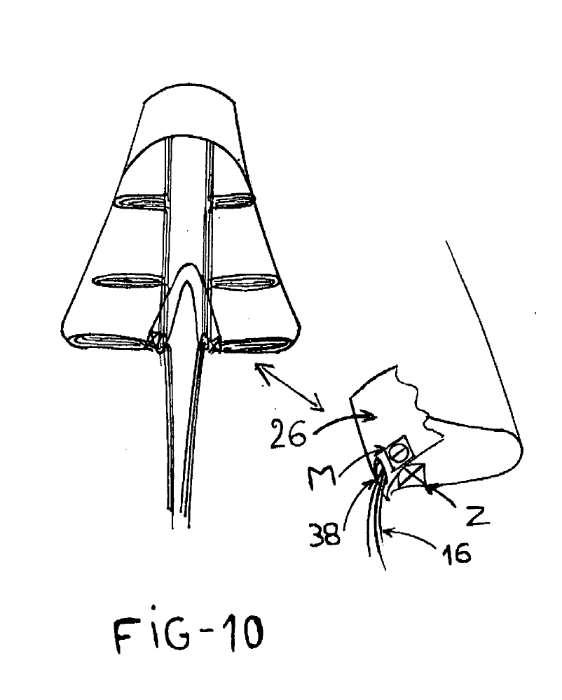

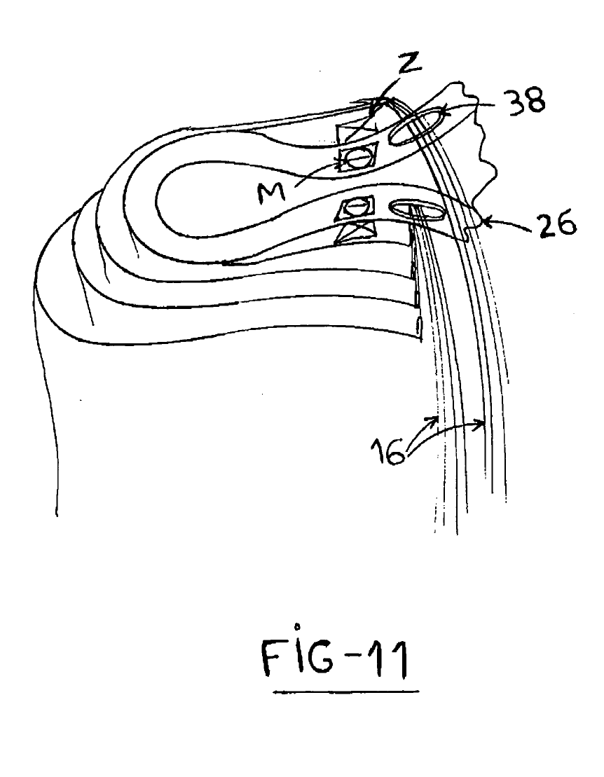

In FIGS. 10 and 11 is shown an exemplary embodiment of the variation of the device according to the invention disposed during packing, thus several magnetic elements Z positioned as slider stop B of the canopy are used, the positive electric charges of the magnets represented by (+) are located in the same direction (toward the canopy centre) in order to repulse at each other, between magnetic elements Z disposed on the canopy 12 during packing.

The magnetic elements M located on the slider 26 have negative electric charges represented by a (−) directed toward the lower surface 30 of the canopy, in order to naturally adhere to said first elements while repulsing at each other between magnetic elements M located on the slider 26 during packing.

Preferably, the slider stops B formed by the magnetic element Z and its envelope act as rigidifying element and replace the discs or rings usually used, or the magnetic elements Z can be added by incorporation with the rigidifying discs made of plastic or metal.

The size and the shape of the magnetic elements Z are selected so as to be integrated in a textile envelope having a sufficient stiffness/rigidity, identical for all slider stops B of prior art sliders. In a variation of the device according to the invention, the magnetic elements Z can be disposed positioned without textile envelope, as known in the art.

The slider stops B used to incorporate magnetic elements are preferably those of group B and C, but can also be those of group A or D without changing anything to the spirit of the invention.

The magnetic elements M positioned on the slider 26 can be captured preferably by stitching thanks to a housing on the circumferential mounting frame 40, or on the woven fabric 50.

Preferably, a magnetic element M is positioned proximate to each grommet 38 of the slider 26 or a Magnet Block is positioned with its counterpart in the ends slider stops B.

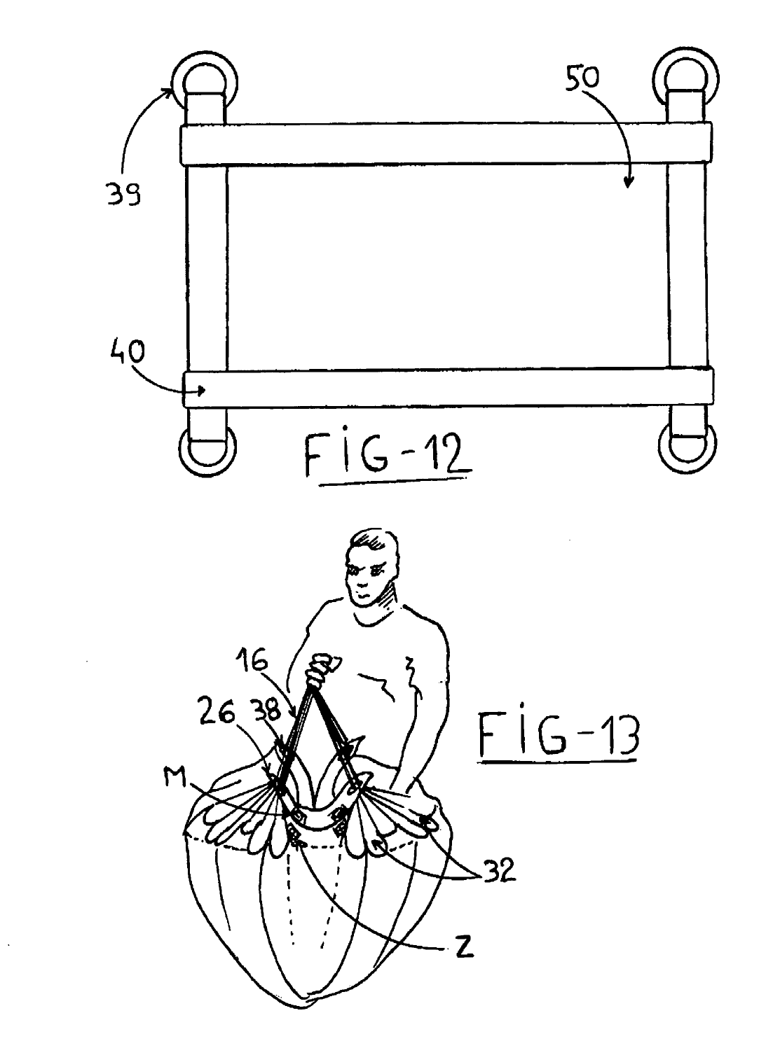

In a different embodiment of the device according to the invention, the securing means of the slider 26 on the canopy 12 comprises at least one magnetic element Z, capable of generating a magnetic field, and to attract a ring with a magnetic body positioned outside the woven fabric 50 of the slider, as those represented by the rings 39 in FIG. 12 or a grommet swaged in the slider fabric, like the grommets 38 shown in the preceding figures, grommets consisting of a material which is not normally magnetic, but is nevertheless attracted by the magnetic field of the first magnetic element Z.

In this last embodiment of a variation of the device according to the invention, the type of material employed for the ring 39 or the grommet 38 of the slider 26 through which are passed suspension lines 16 of the parachute, can be for example, from any ferrous material, such as iron, cast iron, steel, nickel, cobalt, vanadium, preferably the 17-4 PH which is a structural curing stainless steel, commonly designed high-strength steel (HS).

In another embodiment of the device according to the invention, a first magnetic element M and a second magnetic element Z, the material of which is not normally magnetic but is attracted by the magnetic field of said first element M, can be reversely respectively provided on the slider 26 and on the lower surface 30 of the canopy 12.

In another variation of the device according to the invention, shown in FIG. 13 and more particularly intended to the three cellular canopies, a permanent magnet Z is positioned on each side of the central cell at the lower surface 30 of the leading edge 34 of the central cell, and a permanent magnet M is positioned on each side of the slider 26 at a level corresponding to said magnets Z, such that their proximity is such that they naturally adhere during packing, when the slider 26 is positioned according to a cross shape.

As shown in FIG. 13, it can be seen that, as known in the prior art, the cells 32 are divided into 3 cells, this arrangement of the variation of the device according to the invention will be preferred for the multi-cellular canopies.

The permanent magnet M on the slider 26 is directed such that its pole is opposed to the pole of said first element Z or even the element M can be made of a material which is not normally magnetic but which is attracted by the magnetic field of said first permanent magnet Z.

This arrangement of elements Z and M guarantees the perfect arrangement of the slider 26 on the central cell during packing and conditioning relating to the multi-cellular canopies.

According to a preferred embodiment, an object of the invention is an arrangement of the magnetic elements into one or more attachment points spaced apart at each other, at a sufficient distance so the attraction of a magnetic element with the other one does not to occur, for example, between the magnetic elements Z positioned in the slider stops B on the stabilizer panels of the canopy 12, or between the magnetic elements M positioned proximate to the grommets 38 of the slider 26.

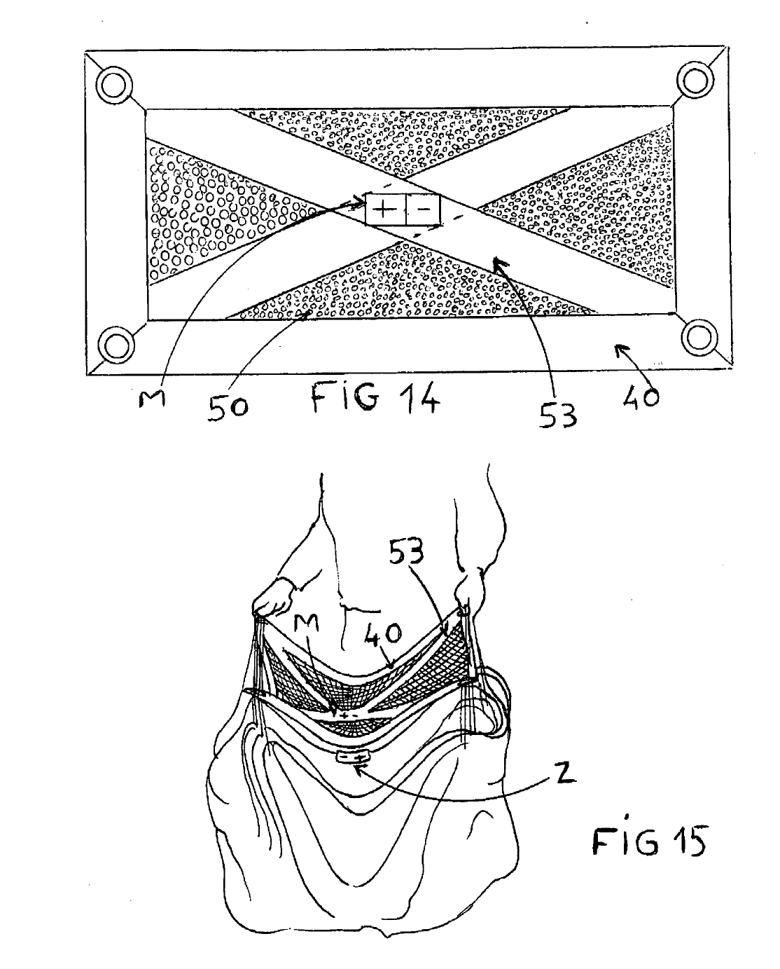

In another variation of the invention shown in FIG. 14 which uses a mesh slider, the magnetic elements M are positioned at the centre of the cross-brace 53 and, for example, the magnetic elements Z are positioned at the centre of the lower surface of the canopy between the attachments points C and D, so that the slider is perfectly conditioned at the centre.

In the different previously given examples, the slider 26 is shown with 4 grommets 38 or rings 39 but as known per se on load parachutes, the slider 26 can consist in a plurality of grommets 38 or rings 39 each crossed by a bundle of suspension lines 16 passing through them, it is possible to add magnetic elements or Magnet Blocks proximate to different grommets 38 and slider stops B, without changing anything to the spirit of the invention.

The slider woven fabric can be single-layered or multi-layered.

1- Parachute comprising a canopy and an opening retardation system, said opening system consisting of a slider and slider holding means, said means comprising at least a pair of magnetic elements, one magnetic element of each pair being a permanent magnet and the other magnetic element of each pair being a permanent magnet or a material that is attracted to a permanent magnet, and, for each pair, one magnetic element being positioned on the lower surface of the canopy and the other magnetic element being at a location on the slider such that it overlays the one magnetic element and adheres to it by magnetism, maintaining the position of the slider during packing and conditioning.

2- Parachute according to claim 1, wherein said slider is provided with grommets for the passage of stabilizers of the canopy and said slider holding means are arranged so that, during the spreading phase of the canopy, the contact of said grommets of said slider against slider stops on said stabilizers of the canopy is assured.

3- Parachute according to claim 1, wherein said slider holding means are arranged to ensure by magnetism the holding of the slider in order for a woven fabric constituting said slider to take the shape of a dome before the slider holding means release.

4- Parachute according to claim 1, wherein said slider holding means are arranged so that their release occurs at the inflating phase of cells of canopy.

5- Parachute according to claim 4, wherein said slider holding means are selected to have sufficient attraction to hold said slider in place until it is pulled off by the opening of the canopy.

6- Parachute according to claim 1, wherein, for each pair of magnetic elements, the attraction force of the magnetic element on the canopy is produced with an alternating positive and negative twin poled assembly or with a single pole located at the lower surface directed toward the slider.

7- Parachute according to claim 1, wherein, for each pair of magnetic elements, the attraction of the magnetic element on the slider is produced with an alternating positive and negative twin poled assembly directed toward the lower surface, arranged in a direction opposite to the one on the canopy, or with a single opposite pole directed toward the lower surface of the canopy.

8- Parachute according to claim 1, wherein, for each pair, the magnetic element provided on the lower surface of the canopy is located alone or in combination with others, provided either on or near the slider stops, or on the trailing edge, or on the centre cell, or any other location of the lower surface of the canopy.
